(19) United States
(12) Patent Application Publication
(10) Pub. No.: US 2012/0229930 A1
(43) Pub. Date: Sep. 13, 2012

(54) SELF-SERVO WRITER WITH ITERATIVE LEARNING CONTROL MECHANISM AND METHOD OF OPERATION THEREOF

(75) Inventors: Zhi Wang, San Jose, CA (US); Hao-Ping Wen, Sunnyvale, CA (US)

(73) Assignee: SAMSUNG ELECTRONICS CO., LTD., Gyeonggi-Do (KR)

(21) Appl. No.: 13/045,505

(22) Filed: Mar. 10, 2011

(51) Int. Cl. G11B 21/04; G11B 15/46

(52) U.S. Cl. 360/70; 360/75; 360/73.03; G9B/15.054; G9B/21.008

(57) ABSTRACT

A method of operation of a servo writing system includes: initializing a disk and a head positioned over the disk for writing a servo pattern on the disk; calculating a target velocity profile for writing the servo pattern on the disk; setting a movement profile for operating the disk, the head, or a combination thereof to the target velocity profile; determining a back electromotive force from operating the disk, the head, or a combination thereof according to the movement profile; calculating an actual profile of the movement of the disk, the head, or a combination thereof from the back electromotive force; and adjusting the movement profile by the actual profile to match the actual profile to the target velocity profile for writing the servo pattern on the disk.

### TECHNICAL FIELD

The present invention relates generally to a disk drive manufacturing system, and more particularly to a system for writing digital servo patterns.

### BACKGROUND ART

A hard disk drive typically contains one or more disks clamped to a rotating spindle, at least one head for reading data from and/or writing data to the surfaces of each disk, and an actuator utilizing linear or rotary motion for positioning the read/write head(s) over selected data tracks on the disk(s). A rotary actuator is a complex assembly that couples a slider on which a head is attached or integrally formed to a pivot point that allows the head to sweep across a surface of a rotating disk.

A servo system uses positioning data read by the head from the disk to determine the position of the head on the disk. In common servo schemes, positioning data can be included in servo wedges, each including servo patterns. Servo wedges can be written to each disk using a media writer, prior to assembly of the hard disk drive. Alternatively, a reference surface of one disk can be used to write servo wedges on blanks disks substituted for media-written disks in an assembled hard disk drive.

Over the past decade, Self Servo-Writing (SSW) has been adopted for writing servo patterns. Higher throughput of the servo writing process can be maintained without increasing the production cost and process time using SSW.

There are a few established approaches to write spirals. However, they often rely on the external servo positioning system and are therefore invasive, requiring extra dissemble and assemble effort. Moreover, their cost is still significant due to clean room occupation.

Thus, a need still remains for a self-servo writer with iterative learning control. In view of the advances in disk drive technology with ever decreasing spacing between the data tracks, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a servo writing system including: initializing a disk and a head positioned over the disk for writing a servo pattern on the disk; calculating a target velocity profile for writing the servo pattern on the disk; setting a movement profile for operating the disk, the head, or a combination thereof to the target velocity profile; determining a back electromotive force from operating the disk, the head, or a combination thereof according to the movement profile; calculating an actual profile of the movement of the disk, the head, or a combination thereof from the back electromotive force; and adjusting the movement profile by the actual profile to match the actual profile to the target velocity profile for writing the servo pattern on the disk.

The present invention provides a servo writing system including: a disk; a head positioned over the disk for writing a servo pattern on the disk; a target module, coupled to the disk and the head, for calculating a target velocity profile for writing the servo pattern on the disk; an operation module, coupled to the disk and the head, for setting a movement profile for operating the disk, the head, or a combination thereof to the target velocity profile; a sensor module, coupled to the disk and the head, for determining a back electromotive force from operating the disk, the head, or a combination thereof according to the movement profile; a calculation module, coupled to the sensor module, for calculating an actual profile of the movement of the disk, the head, or a combination thereof from the back electromotive force; and an adjustment module, coupled to the calculation module, for adjusting the movement profile by the actual profile to match the actual profile to the target velocity profile for writing the servo pattern on the disk.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a top view of a servo writing system with iterative learning control in an embodiment of the present invention.

FIG. 2 is a plan view of a servo pattern written on the disk of FIG. 1.

FIG. 3 is a profile for operating the servo writing system of FIG. 1 to write the servo pattern of FIG. 2.

FIG. 4 is a detailed view of the back electromotive force of FIG. 3 having noise components.

FIG. 5 is an exemplary block diagram of the servo writing system.

FIG. 6 is an exemplary block diagram of a second embodiment of the servo writing system.

FIG. 7 is a flow chart of a method of operation of the servo writing system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals.

For expository purposes, the term “horizontal” as used herein is defined as a plane parallel to the plane or surface of the disk, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact between elements.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

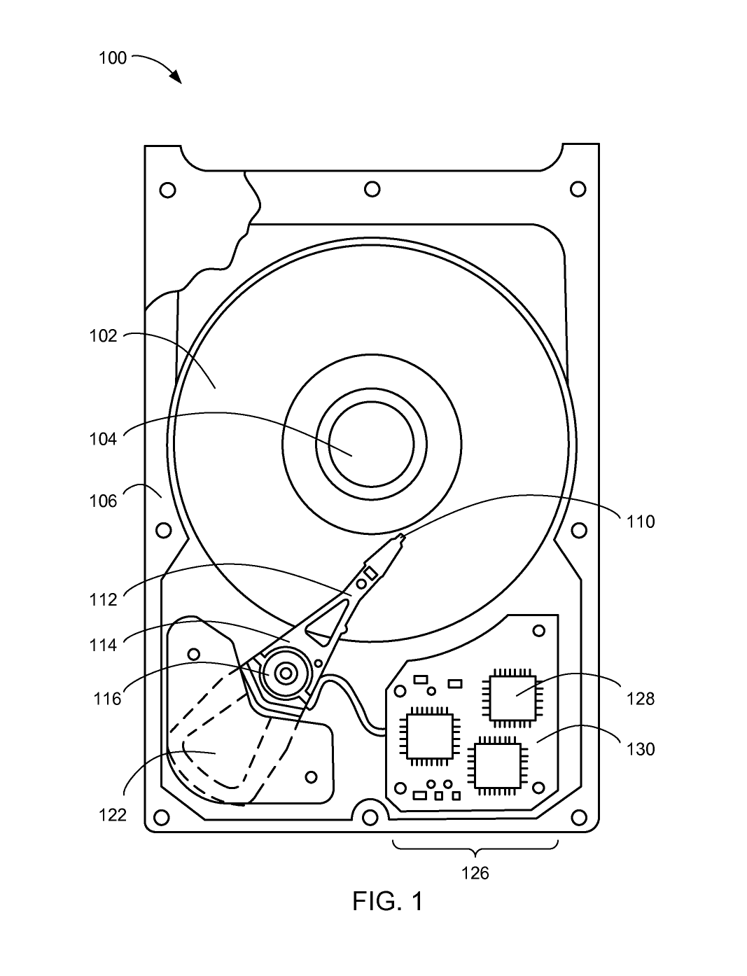

Referring now to FIG. 1, therein is shown a top view of a servo writing system 100 with iterative learning control in an embodiment of the present invention. The top view of the servo writing system 100 depicts one or more disk 102 that are rotated by a spindle motor 104.

The disk 102 can be made of a light aluminum alloy, ceramic/glass or other suitable substrate, with magnetic material deposited on one or both sides of the disk. The magnetic layer has tiny domains of magnetization for storing data. The disk can be rotated at a constant or varying rate typically ranging from less than 3,600 to more than 15,000 RPM (speeds of 4,200, 5,400, and 7200 RPM are common in hard disk drives designed for mobile devices such as laptop computers).

The spindle motor 104 may be mounted to a base plate 106. A head 110 may be gimbal mounted to a flexure arm 112 as part of a head gimbal assembly (HGA). The flexure arm 112 is attached to an actuator arm 114 that is pivotally mounted to the base plate 106 by a bearing assembly 116. A voice coil is attached to the actuator arm 114. The voice coil is coupled to a magnet assembly to create a voice coil motor (VCM) 122. Providing a current to the voice coil will create a torque that swings the actuator arm 114 and moves a head 110 across the disk 102.

The hard servo writing system 100 may include a circuit assembly 126 that includes a plurality of integrated circuits 128 coupled to a printed circuit board 130. The circuit assembly 126 is coupled to the VCM 122, the head 110 and the spindle motor 104 by wires (not shown).

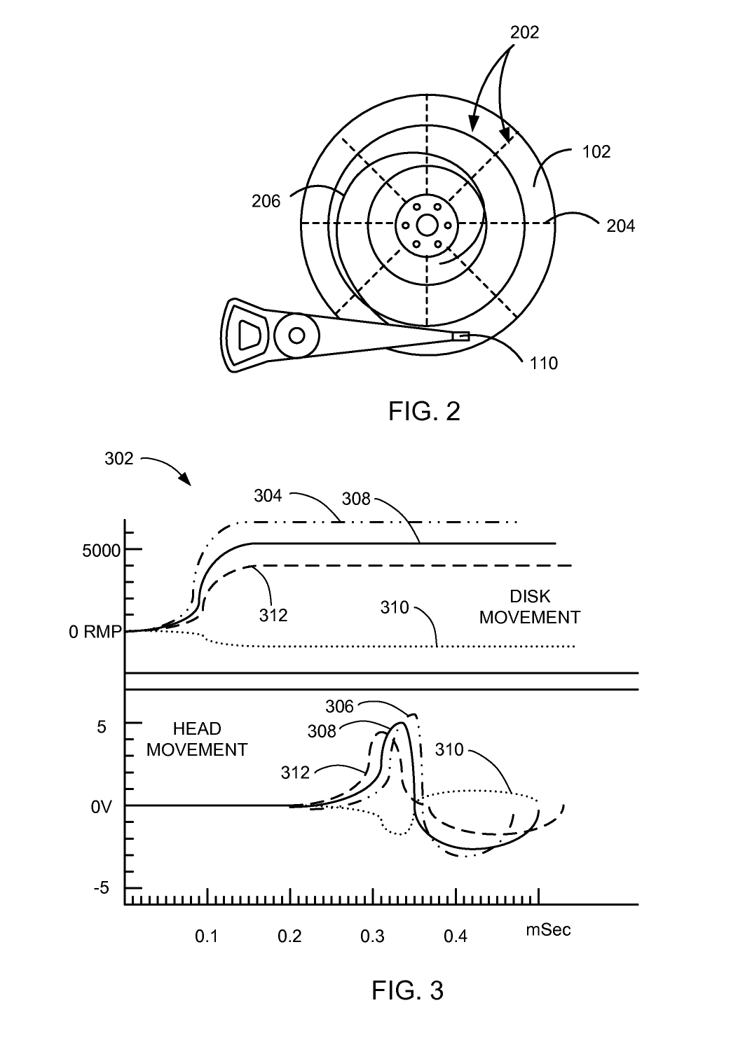

Referring now to FIG. 2, therein is shown a plan view of a servo pattern 202 written on the disk 102 of FIG. 1. The servo pattern 202 is a physical arrangement or layout of the servo signals. Servo signals are predetermined signals or settings on the disk 102 and are part of the data header. Servo signals can be written on the disk 102 during manufacturing process. The disk drives and the systems using the disk drives can use the servo signals to place the head 110 in the designated region to read the specified data from the disk 102.

The servo pattern 202 can be written through the head 110. To write the servo pattern 202 current can be sent through the head 110 to change the magnetic properties on the surface of the disk 102. The servo signals can be placed on specific regions on the disk 102 to form the servo pattern 202.

For example, the servo pattern 202 can be a radial pattern 204 or a spiral servo-pattern 206. The radial pattern 204 is where the sets of servo signals form a straight line from the center of the disk to the outer edge in a radial manner. The straight lines of servo signals can be spaced equally apart.

The tracks on all disk surfaces contain small segments of servo data often referred to as servo wedges or servo sectors. Each track can contain an equal number of servo wedges, spaced relatively evenly around the circumference of the track.

The spiral servo-pattern 206 is where the sets of servo signals form a curved line nearly perpendicular to the radial lines and gradually move from the center of the disk 102 outward or from the outer edge inward. The spiral servo-pattern 206 can constitute swirls.

The spiral servo-pattern 206 can be written by moving the head according to a pre-set pattern while the disk 102 is spinning Details regarding the writing of the spiral servo-pattern 206 will be discussed below.

Computer hard disk drives employ the electromagnetic read/write head to write and read data on the data magnetic disks. The data is stored on the concentric data tracks on the disk surface. The read/write element is mounted on the VCM actuator. To guarantee the quality of the read/write data, a closed loop servo system accurately controls the VCM 122 of FIG. 1, which positions the head 110 on the data track using the servo sector information embedded in a dedicated portion of each data track.

Each servo sector comprises a preamble for synchronizing the gain control and the data demodulator clock, the sync mark for synchronizing the data field, which includes the coarse head position such as the track number and the servo bursts providing the fine head position information. During the normal operation, the servo sector data is processed by the disk drive to generate the head position for closed loop maintain the head 110 over the centerline of the target track while reading or writing data. In the past, external servo writer have been used to write the concentric product servo sectors to the disk surface during manufacturing. External servo writers employ extremely accurate head positioning mechanics such as a laser interferometer, to ensure the product sectors at the proper location across the disk surface. However, the external servo writer is expensive and requires a clean room environment.

The disk drive then self servo writes the product servo sectors while closed loop control using the spiral information. Typically, there are few hundreds of spiral tracks compared to few hundred thousands of product data tracks. Therefore, the clean room time saving is about a factor of thousand. Each spiral track consists of the high frequency signal interrupted at a pre-determined interval by a sync mark. Each frame is defined as the spiral signal from sync to sync. The read signal is processed to detect the sync marks in the spiral tracks to synchronize a servo write clock. It is also processed to demodulate the high frequency signal in the spiral tracks to generate a position error signal used to maintain the read head along a desired circular target path and writes the product servo sectors.

In actual implementation, the disk is divided into two bands depending on the read/write head geometry. For the first band, the disk drive sequentially writes the product sectors by controlling the VCM 122 from OD to the boundary. It then slowly seeks to the ID and sequentially seeks outward to write the product sectors on the second band from ID to the boundary. For S spirals, the spiral to spiral time, which is the track following controller sampling time is the ratio of the revolution period over S. During halftrack seeking, the prior-art techniques move the VCM 122 very slowly so that the spiral to spiral time is the same as the track following time.

Referring now to FIG. 3, therein is shown a profile for operating the servo writing system 100 of FIG. 1 to write the servo pattern 202 of FIG. 2. The servo writing system 100 can have a movement profile 302 having a disk-movement profile 304 and a head-movement profile 306.

The movement profile 302 is a set of readings, settings, or a combination thereof regarding the movement of the components within the servo writing system 100. For example, the movement profile 302 can show the current or voltage settings or the velocity settings of the head 110 of FIG. 1, the disk 102 of FIG. 1, or a combination thereof. Also for example, the movement profile 302 can show the readings regarding the actual speed or positions of the head 110, the disk 102, or a combination thereof.

The disk-movement profile 304 is a set of settings regarding the movement of the disk 102. For example, the disk-movement profile 304 can have locations of a certain reference point on the disk 102, angular or rotational speed of the disk 102, or amount of energy used to accelerate the disk 102, such as current or voltage.

The disk-movement profile 304 can correlate the readings, settings, or a combination thereof with time. For example, the disk-movement profile 304 can log the targeted angular velocity of the disk 102 starting from when the disk 102 starts rotating. Also, for example, the disk-movement profile 304 can show the speed readings relative to a reference point, such as initialization.

The disk-movement profile 304 can have multiple forms. For example, the disk-movement profile 304 can be a linked list or a table having values and the corresponding times in sequence. Also, for example, the disk-movement profile 304 can be a graph that has the quantity represented across the vertical axis and time across the horizontal axis.

The head-movement profile 306 is a set of settings regarding the movement of the head 110. For example, the head-movement profile 306 can have locations of the head 110, the velocity of the head, or the amount of energy used to move the head 110, such as current or voltage.

The head-movement profile 306 can be similar to the disk-movement profile 304 and correlate the readings, settings, or a combination thereof with time. For example, the head-movement profile 306 can correlate the targeted speeds and directions of the head 110 to the time after the disk 102 initializes or after the disk 102 achieves a targeted rotational speed and maintains the speed for a pre-determined length of time. Also, for example, the head-movement profile 306 can show the location readings of the head 110 relative to initialization of the servo writing system 100.

The movement profile 302 can also show a target velocity profile 308 and a back electromotive force (BEMF) 310. The target velocity profile 308 is the velocity or a pattern of velocity for operating the servo writing system 100. For example, the target velocity profile 308 can be the angular speed for rotating the disk 102. Also, for example, the target velocity profile 308 can be the pattern of velocity for moving the head 110 to write the spiral servo-pattern 206.

The BEMF 310 is the electrical force created when a wire winding moves across magnetic fields. For example, the BEMF 310 can be the voltage and current created when generators rotate the wire windings across magnets of alternating polarity.

The BEMF 310 can exist when electrical motors are used. The voltage and current applied to the windings can turn the motor and the BEMF 310 can oppose the supply voltage and current once the motor starts moving. The BEMF 310 can also be redirected not to oppose the supply power by using secondary windings in the motor.

The BEMF 310 can be measured in variety of ways. For example, the BEMF 310 can be measured on the secondary windings when secondary windings exist. Also, for example, in three-phase motors, the supply voltage can power two phases at a time and the BEMF 310 can be measured from the third phase windings. For further example, the BEMF 310 can be measured by measuring the voltage drop across the windings and subtracting it from the supply voltage.

The movement profile 302 can further show an actual profile 312. The actual profile 312 is the set of readings for the actual movements, locations, or speeds of the different components in the servo writing system 100. For example, the actual profile 312 can be the angular speed readings of the disk 102. Also, for example, the actual profile 312 can be the actual locations of the head 110.

The actual profile 312 can be similar to other components of the movement profile 302, such as the target velocity profile 308 or the head-movement profile 306. The actual profile 312 can be super-imposed on the target velocity profile 308 to show the difference between the target velocity profile 308. Differences can exist due to differing properties in components, signal noise or interference, or the shape and placement of the disk 102.

The actual profile 312 can be measured using sensors, such as speed sensors or location sensors. The actual profile 312 can also be calculated from the BEMF 310. For example, the actual profile 312 can be the integral of the BEMF 310. Also, for example, the actual profile 312 can be calculated by multiplying the BEMF 310 with a factor, delaying or shifting the BEMF 310 in time, or a combination thereof.

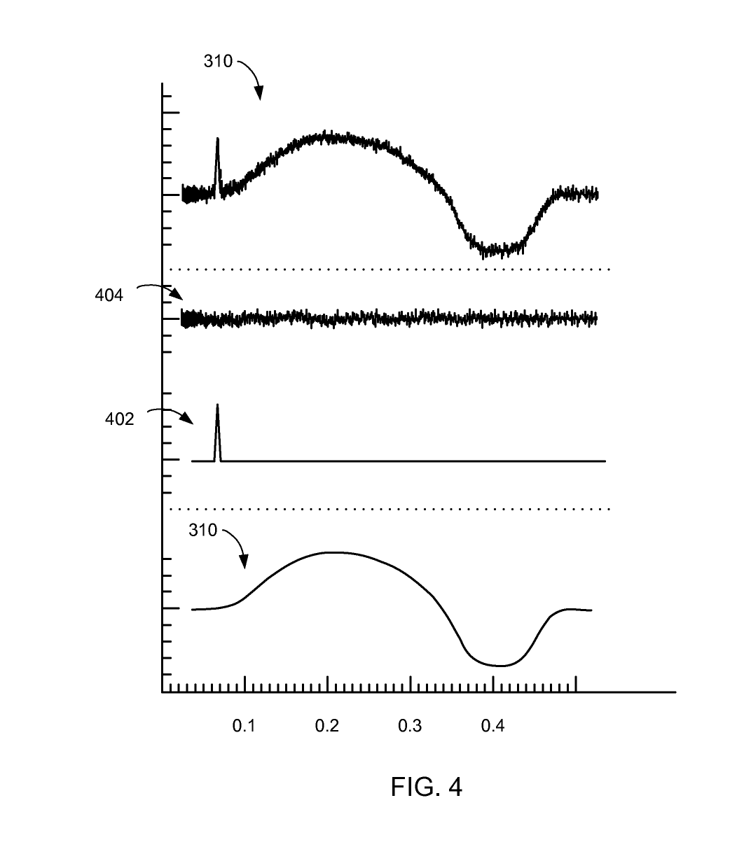

Referring now to FIG. 4, therein is shown a detailed view of the back electromotive force 310 of FIG. 3 having noise components. The BEMF 310 can have a repetitive disturbance 402 and a white noise 404.

The repetitive disturbance 402 is a repetitive pattern of undesired changes in any given signal. The repetitive disturbance 402 can exist in the BEMF 310 readings. For example, the repetitive disturbance 402 can be a repeated pattern of fluctuations in the signal amplitudes or an errant spike or set of spikes that appear with some regularity within the BEMF 310.

The repetitive disturbance 402 can be caused by many sources. For example, flex bias force, the position of center of the disk 102 of FIG. 1 relative to the center of the spindle motor 104 of FIG. 1, glitches or deformities on the surface of the disk 102, from the inherent properties of the components of the disk 102, or a combination thereof.

The repetitive disturbance 402 can be one or a set of undesired changes undesired change, such as an unexpected voltage spike or oscillation, which occurs at nearly the same time during each execution of the disk movement profile 304 and the head movement profile 306. For example, the servo-writing system 100 can adjust and fine tune the disk movement profile 304 and the head movement profile 306 using multiple iterations.

Continuing with the example, when the disk 102 or the head 110 has irregularities, the actual profile 312 of each iteration will have the effects of the irregularities around the same time. The repetitive disturbance 402 can be effects of irregularities repeated across iterations. The details regarding the iterative approach and accounting for the repetitive disturbance 402 will be discussed below.

The white noise 404 is a random pattern of disturbances in any given signal. The white noise 404 can deform the BEMF 310 readings. For example, the value of the BEMF 310 readings can be increased or decreased by a random value at random frequencies, resembling static looking patterns overlaying the overall signal.

The white noise 404 can be caused by many sources. For example, the heat generated by the components within the servo writing system 100 of FIG. 1, the differing granularity of the different components, external magnetic fields, changes in the flying height of the head 110, or a combination thereof.

The servo writing system 100 can filter out the repetitive disturbance 402 and the white noise 404 from the BEMF 310. Details regarding the filtering will be discussed below.

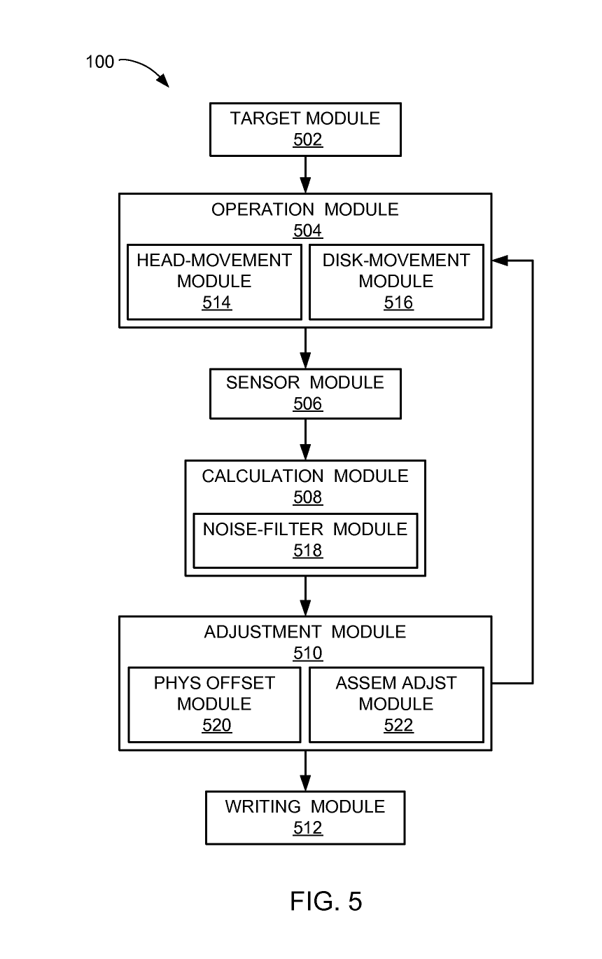

Referring now to FIG. 5, therein is shown an exemplary block diagram of the servo writing system 100. The servo writing system 100 can include a target module 502, an operation module 504, a sensor module 506, a calculation module 508, an adjustment module 510, and a writing module 512.

The target module 502 can be coupled to the operation module 504, which can be coupled to the sensor module 506. The sensor module 506 can be coupled to the calculation module 508, which can be coupled to the adjustment module 510. The adjustment module can be couple to the writing module 512 and also the operation module 504.

The purpose of the target module 502 is to calculate the speeds and the timing for writing the servo data according to a desired pattern. The target module 502 can calculate the target velocity profile 308 of FIG. 3 for writing the servo pattern 202 of FIG. 2 on the disk 102 of FIG. 1. For example, the target module 502 can calculate the target velocity profile 308 for the head 110 of FIG. 1, the disk 102, or a combination thereof for writing the spiral servo-pattern 206 of FIG. 2 on the disk 102.

The target module 502 can calculate the target velocity profile 308 by calculating the desired rotational speed of the disk 102. The target module 502 can calculate the rotational speed based on the properties of the spindle motor, such as load capacity or model number, and the properties of the disk 102, such as radius or the serial number. The target module 502 can use a predetermined formula, setting, a table, or a combination thereof to calculate the desired rotational speed of the disk 102.

The target module 502 can also calculate the target velocity profile 308 by using the shape of the servo pattern 202 and the rotational speed of the disk 102. The target velocity profile 308 can be the velocity or position of the head 110 across time, such that the head 110 would trace the shape of the servo pattern 202 over the disk 102 while the disk 102 is rotating.

The target velocity profile 308 can have a pattern of values for the velocity of the head 110 alone or in combination with varying values of the rotational speed of the disk 102. The target module 502 can use a predetermined formula, setting, a table, or a combination thereof to calculate the desired rotational speed of the disk 102.

The target module 502 can use the target velocity profile 308 can use the integrated circuits 128 of FIG. 1 to calculate the target velocity profile 308. The target module 502 can store the target velocity profile 308 back into the integrated circuits 128 or into other memory components on the printed circuit board 130 of FIG. 1. The target module 502 can also be a dedicated circuitry that calculates and stores the target velocity profile 308.

The purpose of the operation module 504 is to plan the sequence of settings to move the different components within the servo writing system 100. The operation module 504 can set the movement profile 302 of FIG. 3 for operating the servo writing system 100. For example, the operation module 504 can initialize the movement profile 302 to the target velocity profile 308.

Also, for example, the operation module 504 can adjust the movement profile 302, such as change the intensity or the timing of the settings, based on inputs from other modules, such as the adjustment module 510. The operation module 504 can adjust the movement profile 302 by moving the values of the movement profile 302 according to the differences calculated by the adjustment module 510. The operations of the adjustment module 510 will be discussed below.

The operation module 504 use the target velocity profile 308 can use the integrated circuits 128 to set the movement profile 302. The operation module 504 can store the movement profile 302 back into the integrated circuits 128 or into other memory components on the printed circuit board 130. The operation module 504 can also be a dedicated circuitry that calculates and stores the movement profile 302.

The operation module 504 can have a head-movement module 514 and a disk-movement module 516. The purpose of the head-movement module 514 is to plan the movement of the head 110 to trace the servo pattern 202 over the disk 102. The head-movement module 514 can set the head-movement profile 306 of FIG. 3 for controlling the VCM 122.

For example, the head-movement module 514 can initially set values and timing of the head-movement profile 306 to be equal to a portion of the target velocity profile 308 corresponding to the movement of the head 110. Afterwards, the head-movement module 514 can adjust the head-movement profile 306 changing the values and the timing according to the adjustments from the adjustment module 510.

Also, for example, the head-movement module 514 can set the values and timing by calculating positions of the head 110 necessary to trace the servo pattern 202 over a moving surface. The head-movement module 514 can calculate the values and timing for moving the head 110 by looking up the initial geometry of the servo pattern 202, integrating or differentiating the shape, using a predetermined equation using the shape, or a combination thereof.

The operation module 504 can use the integrated circuits 128 or other components on the printed circuit board 130, or a combination thereof to set the head-movement profile 306. The operation module 504 can be coupled to the VCM 122 via a wire connection. The operation module 504 can also be dedicated circuitry on the VCM or an external software module that is coupled to the VCM through the integrated circuits 128.

The purpose of the disk-movement module 516 is to plan the movement of the disk 102. The disk-movement module 516 can set the disk-movement profile 304 of FIG. 3. The disk-movement module 516 can set the disk-movement profile 304 to operate the spindle motor 104 at a targeted rotational speed, such as 8000 rpm.

The disk-movement module 516 can also set the disk-movement profile 304 to have different speeds at different times to aid the head 110 trace the servo pattern 202 over the disk 102. The disk-movement module 516 can initially set the disk-movement profile 304 to be equal to a portion of the target velocity profile 308 corresponding to the movement of the disk 102. Afterwards, the disk-movement module 516 can adjust the disk-movement profile 304 similar to the head-movement module 514.

The operation module 504 can use the integrated circuits 128 to set the disk-movement profile 304. The disk-movement module 516 can store the disk-movement profile 304 back in the integrated circuits 128, other memory components on the printed circuit board 130, other externally coupled components, or a combination thereof.

The operation module 504 can initiate the VCM to operate according to the head-movement profile 306. The operation module 504 can simultaneously initiate the spindle motor 104 to operate according to the disk-movement profile 304.

In alternative embodiments, the operation module 504 can operate the spindle motor 104 and further set and adjust the disk-movement profile 304. After setting and adjusting the disk-movement profile 304, the operation module 504 can operate the VCM 122 to set and adjust the head-movement profile 306.

The purpose of the sensor module 506 is to read the actual position or speed of the components in the servo writing system 100. The sensor module 506 can determine the BEMF 310 from operating the servo writing system 100 according to the movement profile 302. The sensor module 506 can determine the BEMF 310 from the VCM 122, the spindle motor 104, or a combination thereof.

The sensor module 506 can determine the BEMF 310 in a variety of ways. For example, the sensor module 506 can include a voltage or a current sensor coupled to a secondary winding in the VCM 122, the spindle motor 104 or a combination thereof. The sensor module 506 can determine the BEMF 310 by reading the voltage or current sensor.

Also, for example, the sensor module 506 can have a voltmeter or current meter near the VCM 122, the spindle motor 104 or a combination thereof. The sensor module 506 can subtract the voltage or current from the meter near the motors from the original supply voltage to determine the BEMF 310.

For further example, when the VCM 122 or the spindle motor 104 is a 3-phase motor, the sensor module 506 can use 2 phases at all times according to the movement profile 302. The sensor module 506 can read the voltage or current from the third unused phase winding to determine the BEMF 310.

The sensor module 506 can use the integrated circuits 128 to determine and store the BEMF 310. The sensor module 506 can also use other components, such as sensors, meters, memory components, or a combination thereof that are also part of the circuit assembly 126 of FIG. 1. The sensor module 506 can be coupled to the VCM 122 and the spindle motor 104 by wires or by wireless connections.

The purpose of the calculation module 508 is to calculate the actual movement of the components. Due to numerous factors, such as friction loss or inherent nature of the components and motors, the calculated settings do not always yield expected results. For example, the disk 102 may not move at 8000 rpm even when the settings were calculated to yield a rotational speed of 8000 rpm for the disk 102.

The calculation module 508 can calculate the actual profile 312 of FIG. 3 of the movement of the servo writing system 100 from the BEMF 310. More specifically, the calculation module 508 can calculate the actual profile 312 of the movement of the head 110, the disk 102, or a combination thereof from the BEMF 310.

The calculation module 508 can calculate the actual profile 312 in a number of ways. The calculation module 508 can perform integration, differentiation, or a combination thereof to the BEMF 310 to calculate the actual profile 312. The calculation module 508 can also add or multiply the BEMF 310 by factors. Alternatively, the calculation module 508 can use a predetermined equation or a table with entries corresponding to different values of the BEMF 310 to calculate the actual profile 312.

The calculation module 508 can use the circuit assembly 126 to calculate and store the actual profile 312 from the BEMF 310. The calculation module 508 can also use external components coupled to the sensor module 506 to calculate and store the actual profile 312.

The calculation module 508 can have a noise-filter module 518. The purpose of the noise-filter module 518 is to remove any unwanted noise for calculating the actual profile 312. The noise-filter module 518 can filter the BEMF 310. More specifically, the noise-filter module 518 can filter out the white noise 404 of FIG. 4 from the BEMF 310.

The calculation module 508 can utilize FIR type filter, IIR type filter, or a combination thereof in the circuit assembly 126 to filter the BEMF 310. The calculation module 508 can also utilize adaptive filter routines or FFT related frequency routines as basis for other digital filter, which can be located in the circuit assembly 126 or coupled to it from external components.

In the current embodiment, the servo writing system 100 is described as the noise-filter module 518 filtering the BEMF 310 first and pass the result to the calculation module 508 to calculate the actual profile 312. However, it is understood that the order can be reversed, where the actual profile 312 is calculated first in the calculation module 508 and the actual profile 312 produced is filtered through the noise-filter module 518.

It has been discovered that the servo writing system 100 with the present invention provided the servo writing system 100 that allows for accurate self-servo writing, which drastically reduced cost and increased efficiency in manufacturing disk drives. The actual profile 312 based on the BEMF 310, especially for the movement of the head 110, gives rise to the reduced cost and increased efficiency.

Using the BEMF 310 to calculate the actual movement of the components, especially the head 110, allows for accurate feedback on the actual performance of the components. Such accurate feedback allows for self-servo writing to be done accurately without additional sensors. Furthermore, the accuracy in reading the movement of the head 110 allows for the servo writing system 100 to accurately write the servo data on to the disk 102 in the spiral servo-pattern 206 outside of the clean room, which drastically reduces the cost and increases the efficiency.

The purpose of the adjustment module 510 is to determine the difference between the targeted movement and the actual movement and use the difference to calculate the necessary adjustments. The adjustment module 510 can adjust the movement profile 302 by the actual profile 312 to match the actual profile 312 to the target velocity profile 308 for writing the servo pattern 202 on the disk 102.

The adjustment module 510 can adjust the movement profile 302 by first determining the difference between the actual profile 312 and the target velocity profile 308. The adjustment module 510 can subtract the values of the two profiles at the corresponding time. The difference between the two profiles can be used to adjust the movement profile 302.

For example, when the actual profile 312 is greater than the target velocity profile 308, the adjustment module 510 can subtract the difference between the two from the movement profile 302. Also, for example, when the actual profile 312 is less than the target velocity profile 308, the adjustment module 510 can add the difference between the two, after multiplying the difference by a predetermined factor, to the movement profile 302.

The adjustment module 510 can adjust the head-movement profile 306 utilizing iterative learning control to compare the actual profile 312 with different value of the head-movement profile 306, the disk-movement profile 304, or a combination thereof over multiple iterations. For example, the iterative control routine can be expressed as:

u_{ffwd,i+1}(k)=u_{ffwd,i}(k)+Γ. (1)

The u_{ffwd} (k) stands for the adjustment necessary for the movement profile 302 based on the difference between the actual profile 312 and the target velocity profile 308. The letter “i” stands for the i-th iteration. The symbol “Γ” stands for the function to be designed.

For example, the servo writing system 100 can start the initial iteration, where i=1, using the values of the target velocity profile 308. The values for the next iteration, where i=2 can be a product of the current settings represented by u_{ffwd, i=1}(k), which was set to the target velocity profile 308.

After executing the initial iteration, the differences between the target velocity profile 308 and the actual profile 312 can be used to calculate Γ, which can be combined with the current setting to produce the setting for the next iteration, u_{ffwd, i=2}(k), and passed onto the operation module 504 for the next iteration.

Since the actual profile 312 is used to calculate Γ, the settings for the next iteration can be represented as a function of the BEMF 310, which is represented as u_{fb, i}(k) in the following equation:

u_{ffwd,i+1}(k)=u_{ffwd,i}(k)+λ·u_{fb,i}(k). (2)

The symbol “λ” represents a design parameter that can be varied based on the design of the disk 102 or other parameters. The adjustment module 510 can continue the iterative process until a predetermined upper limit for the number of iterations is reached or the difference between the actual profile 312 and the target velocity profile 308 is within a predetermined threshold, whichever is reached first.

The adjustment module 510 can predetermined the conditions for stopping the iteration based on cumulative data. For example, the adjustment module 510 can set the predetermined threshold for a satisfactory servo pattern as a function of the industry accepted tolerance level.

Also, for example, the adjustment module 510 can perform a statistical analysis and set the iteration limit as the iteration that meets the threshold for satisfactory servo pattern on 80% of units. The adjustment module 510 can also predetermine the conditions for stopping the iteration based on user input, software or hardware manufacturer settings, or a combination thereof.

It has been discovered that the servo writing system 100 in the present invention provided the servo writing system 100 with increased accuracy in writing the servo pattern 202. The use of iterative learning control with the actual profile 312 gives rise to the accuracy.

The servo writing system 100 can determine the actual movement through the BEMF 310. The servo writing system 100 can compare the product of the actual profile 312 to the servo pattern 202 and make necessary adjustments to accurately write the servo pattern 202.

It has also been discovered that the servo writing system 100 in the present invention provided the servo writing system 100 with stability and reliability. The use of iterative learning control with the BEMF 310 gives rise to the stability and the reliability.

The iterative learning control has not previously been used in writing servo patterns. The iterative learning control scheme allows the servo writing system 100 to write the servo pattern 202 with even more accuracy than previously possible. Furthermore, using the BEMF 310 in combination with the iterative learning control scheme reduces the complexity in picking the correct λ.

The introduction of the BEMF 310 into the iterative learning control scheme created the servo writing system 100 that is stable and continually converges the actual profile 312 to the target velocity profile 308. Thus, the servo writing system 100 can reliably write the servo pattern 202 that is desired, especially the spiral servo-pattern 206, on the disk 102 using the BEMF 310 along with the iterative learning control.

The adjustment module 510 can have a physical offset module 520 and an assembly-adjustment module 522. The purpose of the physical offset module 520 is to identify any repetitive interferences in the signals. The physical offset module 520 can identify the repetitive disturbance 402 of FIG. 4 in the BEMF 310.

The assembly process or the inherent characteristics of the components in the servo writing system 100 can introduce disturbances, such as interference or noise. Due to the repetitive nature of the operation in rotating the disk 102, the interferences or noises can have a repetitive nature. For example, a defect on the surface of the disk 102 or the misalignment of the tracks can cause patterns of glitches or fluctuations in signal strength that repeat with the rotation of the disk 102.

The physical offset module 520 can use pattern detection algorithms such as Bayesian approach or frequency analysis using FFT. The physical offset module 520 can identify recurring elements or strong frequency elements that do not correspond to the movement profile 302 as the repetitive disturbance 402.

The physical offset module 520 can use the circuit assembly 126 to identify and store the repetitive disturbance 402. The physical offset module 520 can also use external components, such as computers or dedicated circuitry, to identify and store the repetitive disturbance 402.

The purpose of the assembly-adjustment module 522 is to cancel out any repetitive error signals that may exist. The assembly-adjustment module 522 can also subtract the repetitive disturbance 402 from the actual profile 312. In alternative embodiments, the assembly-adjustment module 522 can also subtract the repetitive disturbance 402 from the BEMF 310.

The adjustment module 510 can use the results of the physical offset module 520 and the assembly-adjustment module 522 to further calculate and refine the actual profile 312 before analyzing the differences. In alternative embodiments, the analysis between iteration can be done before the repetitive disturbance 402 is cancelled out and the actual profile 312 will be conditioned through the sub-modules before the difference values are passed on to the operation module 504.

The assembly-adjustment module 522 can use the circuit assembly 126 to subtract the repetitive disturbance 402 and store the movement profile 302 that is produced. The assembly-adjustment module 522 can also use external components, such as computers or dedicated circuitry, to subtract the repetitive disturbance 402 and store the movement profile 302.

The purpose of the writing module 512 is to write the servo pattern once the movement profile 302 has been refined to trace the servo pattern 202. The writing module 512 can utilize the head to write the servo pattern 202, including the spiral servo-pattern 206 on the disk 102. The writing module 512 can write the servo pattern 202 onto the disk 102 that is blank. The writing module 512 can also overwrite servo over existing data.

The writing module 512 can use the circuit assembly 126, which may include voltage or current source that can be coupled to the head 110. The voltage or current source can send energy into the head 110 and affect the magnetic properties of certain regions on the surface of the disk 102. The writing module 512 can use the integrated circuits 128 to designate when the servo data should be written while the head 110 traces the servo pattern 202 according to the movement profile 302.

It has been discovered that the servo writing system 100 with the present invention provided the servo writing system 100 with improved applicability and reliability. The BEMF 310 and the iterative learning control scheme gives rise to the applicability and the reliability by eliminating the need for servo calibration. Servo calibration is very difficult, if not impossible, since there is no reference signal on the blank disk. The BEMF 310 and the iterative learning control scheme also give rise to the reliability of self-servo writing process since it is able to ensure that the desired speeds are achieved to write the servo pattern 202.

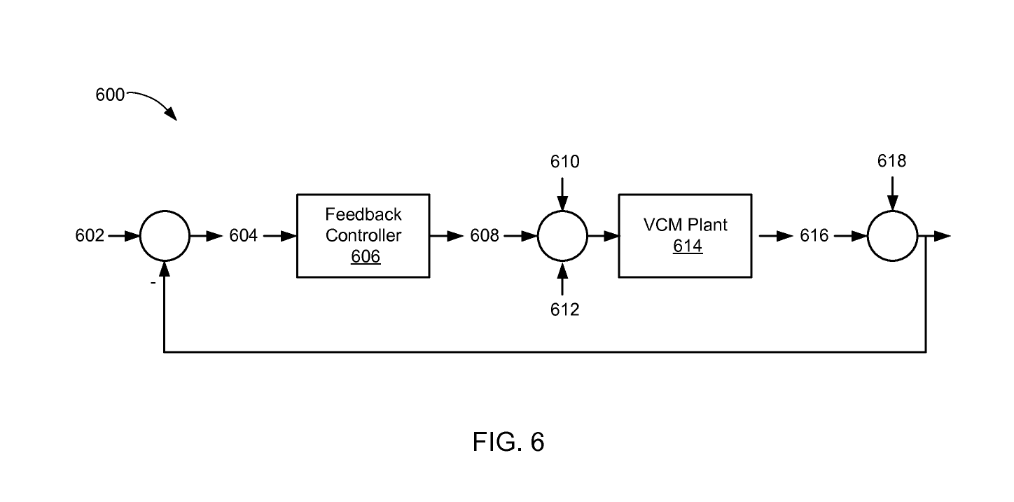

Referring now to FIG. 6, therein is shown an exemplary block diagram of a second embodiment of the servo writing system 600. The servo writing system 600 can have a desired velocity profile 602, a velocity error 604, a feedback controller 606, a feedback output 608, an unknown disturbance 610, a feed-forward control term 612, a VCM plant 614, a head velocity 616, and a measurement noise 618.

The desired velocity profile 602 is the 308 is the velocity or a pattern of velocity for operating the servo writing system 600. The desired velocity profile 602 can include the target velocity profile 308 of FIG. 3. For example, the desired velocity profile 602 can be the angular speed for rotating the disk 102 of FIG. 1 or the pattern of velocity for moving the head 110 of FIG. 1 to write the spiral servo-pattern 206 of FIG. 2. The desired velocity profile 602 can be calculated by the target module 502 of FIG. 5.

The velocity error 604 is the difference between the setting or the desired velocity and the actual velocity. The velocity error 604 can be calculated by subtracting the desired velocity profile 602 and the head velocity 616. The velocity error 604 can be calculated by an adder, such as a module or hardware component, that can add or take the difference between multiple numbers or profiles.

The head velocity 616 is the actual velocity of the head 110. The head velocity 616 can include the actual profile 312 of FIG. 3. The head velocity 616 can be calculated by measuring the BEMF 310 of FIG. 3 from the VCM 122 of FIG. 1. The BEMF 310 can be integrated, differentiated, scaled, offset, or a combination thereof to calculate the head velocity 616. The calculation module 508 of FIG. 5 can calculate the head velocity 616. The BEMF 310 can be measured by the sensor module 506 of FIG. 5.

The feedback controller 606 can be a module or a hardware component that controls the feedback aspect of the iterative learning control process. The feedback controller 606 can calculate the feedback output 608 and the feed-forward control term 612.

The feedback output 608 is the feedback aspect of the iterative learning control. The feedback output 608 can include the movement profile 302 of FIG. 3. The feed-forward control term 612 is the estimation used for cancelling the unknown disturbance 610 through the iterations of learning.

The unknown disturbance 610 is a repetitious disturbance, which is not part of the actual signals. The unknown disturbance 610 can be added into the actual signals due to the nature or property of the components. The unknown disturbance 610 can include the repetitive disturbance 402 of FIG. 4. For example, the unknown disturbance 610 can be a flex bias force or change in the flying height of the head 110 due to the shape of the disk 102 of FIG. 1.

The feedback controller 606 can calculate the feed-forward control term 612 similar to the physical offset module 520 of FIG. 5 identifying the repetitive disturbance 402. The feedback controller 606 can calculate the feed-forward control term 612 using FFT based frequency analysis or Bayesian approach. The details of calculating the feedback output 608 will be discussed below.

The feedback controller can use the circuit assembly 126 of FIG. 1 or the integrated circuits 128 of FIG. 1 to calculate the feed-forward control term 612 and the feedback output 608. The feedback output 608 and the feed-forward control term 612 can be combined to cancel out the effects of the unknown disturbance 610 within the feedback controller 606 or using a separate adder module or component.

For illustrative purposes, separate adder module is shown combining the unknown disturbance 610, the feedback output 608, and the feed-forward control term 612 to model the servo writing system 600 using the iterative learning control process. However, it is understood that the servo writing system 600 can operate differently as stated above.

The VCM plant 614 is a module or component that moves the head 110. The VCM plant 614 can include the VCM 122, coupled to the head 110, and other coupled portions of the circuit assembly 126. The VCM plant 614 can move the head 110 according to the input, such as the feedback output 608 or the movement profile 302.

The VCM plant 614 can measure the BEMF 310 from the VCM 122 and calculate the head velocity 616 as described above. The VCM plant 614 can operate the head 110 according to input and return the head velocity 616 that resulted from operating the head 110.

The measurement noise 618 is signal interferences and disturbances that can be added to actual signals and measurements. For example, the measurement noise 618 can include the white noise 404 of FIG. 4 due to heat, measurement tolerance levels, external electro-magnetic interference, or a combination thereof.

The servo writing system 600 is shown determining the desired velocity profile 602. Separate adder module is shown taking the difference between the desired velocity profile 602 and the head velocity 616 as the feedback parameter. The velocity error 604, shown as the result of the adder module, can be inputted into the feedback controller 606.

The outputs of the feedback controller 606, which can be the feedback output 608 and the feed-forward control term 612, is shown being combined in a separate adder module. For illustrative purposes, the unknown disturbance 610 is shown as a separate signal that is added with the outputs of the feedback controller 606.

The resulting product is shown going into the VCM plant 614, which produces the head velocity 616. The head velocity 616 is shown being combined with the measurement noise 618 in a third adder module. The combined output is shown as the feedback element.

The state-space representation of the VCM plant 614 can be shown as following:

xₚ(k+1)=Aₚ·xₚ(k)+Bₚ·[u_{fb}(k)+u_{ffwd}(k)+d(k)]. (3)

yₚ(k)=Cₚ·xₚ(k). (4)

The vector form representation of the states of the VCM plant 614 is shown as xₚ and the following iteration as xₚ(k+1). The Aₚ, Bₚ, and Cₚ represent scale factors, while u_{fb}(k) represents the feedback output 608. The feed-forward control term 612 is represented as u_{ffwd}(k) and the unknown disturbance 610 is represented as d(k). The head velocity 616 can be represented as yₚ(k), a function of the state of the VCM plant xₚ.

The state-space representation of the feedback controller 606 can be shown as following:

x_{c}(k+1)=A_{c}·x_{c}(k)+B_{c}·[y_{d}(k)−yₚ(k)−n(k)]. (5)

u_{fb}(k)=C_{c}·x_{c}(k). (6)

The vector form representation of the states of the feedback controller 606 is shown as x_{c} and the following iteration as x_{c}(k+1). The A_{c}, B_{c}, and C_{c} represent scale factors, while y_{d}(k) represents the desired velocity profile 602. The head velocity 616 is represented as yₚ(k) and the measurement noise 618 can be represented as n(k). The feed feedback output 608 can be represented as u_{fb}(k), a function of the state of the feedback controller 606 x_{c}(k).

The state-space representations of the VCM plant 614 and the feedback controller 606 can be combined to show the close-loop system as following:

$$\begin{matrix}[ \begin{matrix}{x}_{p} ( k + 1 ) \\ {x}_{c} ( k + 1 )\end{matrix} ] = [ \begin{matrix}{A}_{p} & {B}_{p} \cdot {C}_{c} \\ - {B}_{c} \cdot {C}_{p} & {A}_{c}\end{matrix} ] \cdot [ \begin{matrix}{x}_{p} ( k ) \\ {x}_{c} ( k )\end{matrix} ] + [ \begin{matrix}{B}_{p} \\ 0\end{matrix} ] \cdot [ {u}_{ffwd} ( k ) + d ( k ) ] + [ \begin{matrix}0 \\ {B}_{c}\end{matrix} ] \cdot [ {y}_{d} ( k ) - n ( k ) ] . & ( 7 ) \\ {y}_{p} ( k ) = [ \begin{matrix}{C}_{p} & 0\end{matrix} ] \cdot [ \begin{matrix}{x}_{p} ( k ) \\ {x}_{c} ( k )\end{matrix} ] . & ( 8 )\end{matrix}$$

Using the above state-space representation, the iterative update law can be sought to achieve the iterative control objective. The process can be represented as:

u_{ffwd,i+1}(k)=u_{ffwd,i}(k)+Γ. (1)

The process is designed to minimize the velocity error 604 as the iterations, i, increases. The effect of the velocity error can be represented as:

min_{i→∞}[y_{p,i}(k)−y_{d}(k)]. (9)

Conventionally applying the iterative control law, the servo writing system 600 can be represented as:

u_{ffwd,i+1}(k)=u_{ffwd,i}(k)+λ·VelErrᵢ(k). (10)

The symbol “λ” represents a design parameter that can be varied based on the design of the disk 102 or other parameters. The velocity error 604 is represented as VelErrᵢ(k). Since the design update gain λ is not trivial and can easily become unstable if chosen properly, the servo writing system 600 can utilize the feedback output 608 to stabilize the system. The servo writing system 600 utilizing the feedback output 608 in the iterative control law can be represented as:

u_{ffwd,i+1}(k)=u_{ffwd,i}(k)+λ·u_{fb,i}(k). (2)

It has been discovered that the servo writing system 600 in the present invention provided the servo writing system 600 with increased accuracy in writing the servo pattern 202 with increased stability. The use of iterative learning control with the feedback output 608 gives rise to the accuracy.

The servo writing system 600 can determine the actual movement through the BEMF 310 and the feedback output 608. The servo writing system 600 can compare the product of the feedback output 608 to the servo pattern 202 and make necessary adjustments to accurately write the servo pattern 202. Also, the feedback output 608 reduces the possibility of an improper λ value making the servo writing system 600 unstable and divulging from the servo pattern 202 over multiple iterations.

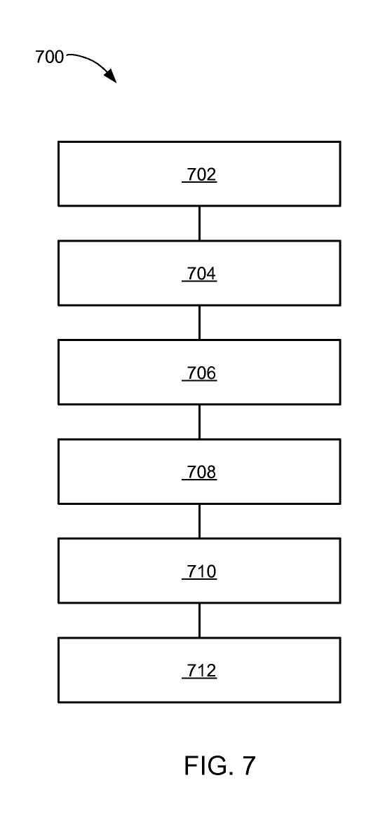

Referring now to FIG. 7, therein is shown a flow chart of a method 700 of operation of the servo writing system 100 in a further embodiment of the present invention. The method 700 includes: providing a disk and a head positioned over the disk for writing a servo pattern on the disk in a block 702; calculating a target velocity profile for writing the servo pattern on the disk in a block 704; setting a movement profile for operating the disk, the head, or a combination thereof to the target velocity profile in a block 706; determining a back electromotive force from operating the disk, the head, or a combination thereof according to the movement profile in a block 708; calculating an actual profile of the movement of the disk, the head, or a combination thereof from the back electromotive force in a block 710; and adjusting the movement profile by the actual profile to match the actual profile to the target velocity profile for writing the servo pattern on the disk in a block 712.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a servo writing system comprising:
initializing a disk and a head positioned over the disk for writing a servo pattern on the disk;
calculating a target velocity profile for writing the servo pattern on the disk;
setting a movement profile for operating the disk, the head, or a combination thereof to the target velocity profile;
determining a back electromotive force from operating the disk, the head, or a combination thereof according to the movement profile;
calculating an actual profile of the movement of the disk, the head, or a combination thereof from the back electromotive force; and
adjusting the movement profile by the actual profile to match the actual profile to the target velocity profile for writing the servo pattern on the disk.

2. The method as claimed in claim 1 wherein adjusting the movement profile includes adjusting the movement profile for writing a spiral servo-pattern.

3. The method as claimed in claim 1 further comprising:
providing a voice coil motor for positioning the head; and
wherein:
setting the movement profile includes setting the movement profile having a head-movement profile for controlling the voice coil motor.

4. The method as claimed in claim 1 further comprising:
providing a spindle motor for moving the disk; and
wherein:
setting the movement profile includes setting the movement profile having a disk-movement profile.

5. The method as claimed in claim 1 further comprising:
writing the servo pattern using the movement profile with the actual profile matching the target velocity profile.

6. A method of operation of a servo writing system comprising:
providing a disk, a head positioned over the disk, and a voice coil motor for positioning the head, for writing a spiral servo-pattern on the disk;
calculating a target velocity profile for writing the spiral servo-pattern on the disk;
setting a head-movement profile to the target velocity profile for operating the voice coil motor to position the head;
determining a back electromotive force from operating the voice coil motor according to the head-movement profile;
calculating an actual profile of the movement of the head from the back electromotive force;
adjusting the head-movement profile by the actual profile to match the actual profile to the target velocity profile for writing the spiral servo-pattern on the disk; and
writing the spiral servo pattern on the disk.

7. The method as claimed in claim 6 wherein providing the disk includes providing the disk that is blank.

8. The method as claimed in claim 6 wherein calculating the actual profile includes filtering the back electromotive force.

9. The method as claimed in claim 6 wherein adjusting the head-movement profile includes utilizing iterative learning control to compare the actual profile with different value of the head-movement profile over multiple iterations.

10. The method as claimed in claim 6 wherein adjusting the head-movement profile includes:
calculating a repetitive disturbance; and
adjusting the head-movement profile to account for the repetitive disturbance.

11. A disk drive storage system comprising:
a disk;
a head positioned over the disk for writing a servo pattern on the disk;
a target module, coupled to the disk and the head, for calculating a target velocity profile for writing the servo pattern on the disk;
an operation module, coupled to the disk and the head, for setting a movement profile for operating the disk, the head, or a combination thereof to the target velocity profile;
a sensor module, coupled to the disk and the head, for determining a back electromotive force from operating the disk, the head, or a combination thereof according to the movement profile;
a calculation module, coupled to the sensor module, for calculating an actual profile of the movement of the disk, the head, or a combination thereof from the back electromotive force; and
an adjustment module, coupled to the calculation module, for adjusting the movement profile by the actual profile to match the actual profile to the target velocity profile for writing the servo pattern on the disk.

12. The system as claimed in claim 11 wherein:
the adjustment module is for writing a spiral servo-pattern on the disk.

13. The system as claimed in claim 11 further comprising:
a voice coil motor, coupled to the head, for positioning the head; and
a head-movement module, coupled to the voice coil motor, for setting the movement profile having a head-movement profile for controlling the voice coil motor.

14. The system as claimed in claim 11 further comprising:
a spindle motor, coupled to the disk, for moving the disk; and
a disk-movement module, coupled to the spindle motor, for setting the movement profile having a disk-movement profile.

15. The system as claimed in claim 11 wherein the head is for writing the servo pattern with the movement profile with the actual profile matching the target velocity profile.

16. The system as claimed in claim 11 further comprising:
a voice coil motor, coupled to the head, for positioning the head for writing a spiral servo-pattern;
a head-movement module, coupled to the voice coil motor, for setting the movement profile having a head-movement profile for controlling the voice coil motor; and
wherein:
the target module is for calculating the target velocity profile for writing the spiral servo-pattern on the disk;
the calculation module is for calculating the actual profile of the movement of the head from the back electromotive force; and
the head is for writing the spiral servo pattern on the disk.

17. The system as claimed in claim 16 wherein the disk is blank before writing the servo pattern.

18. The system as claimed in claim 16 further comprising a noise-filter module, coupled to the sensor module, for filtering the back electromotive force.

19. The system as claimed in claim 16 wherein the adjustment module is for adjusting the head-movement profile utilizing iterative learning control to compare the actual profile with different value of the head-movement profile over multiple iterations.

20. The system as claimed in claim 16 further comprising:
a physical offset module, coupled to the sensor module, for calculating a repetitive disturbance; and
an assembly-adjustment module, coupled to the physical offset module, for adjusting the head-movement profile to account for the repetitive disturbance.
